(19) United States
(12) Patent Application Publication
(10) Pub. No.: US 2013/0326169 A1
(43) Pub. Date: Dec. 5, 2013

(54) Method and Storage Device for Detection of Streaming Data Based on Logged Read/Write Transactions

(71) Applicants: Amir Shaharabany, Kochav Yair (IL); Eyal Sobol, Givat Shmuel (IL); Omer Gilad, Gan Yavne (IL); Oren Cohen, Tel Aviv (IL); Alon Marcu, Tel Mond (IL); Tal Heller, Alonay Abba (IL)

(72) Inventors: Amir Shaharabany, Kochav Yair (IL); Eyal Sobol, Givat Shmuel (IL); Omer Gilad, Gan Yavne (IL); Oren Cohen, Tel Aviv (IL); Alon Marcu, Tel Mond (IL); Tal Heller, Alonay Abba (IL)

(21) Appl. No.: 13/764,287

(22) Filed: Feb. 11, 2013

Related U.S. Application Data
(60) Provisional application No. 61/654,020, filed on May 31, 2012.

(51) Int. Cl. G06F 12/02; G06F 12/06

(52) U.S. Cl. CPC G06F 12/0253; G06F 12/0646
USPC 711/161; 711/170

(57) ABSTRACT

A method and storage device for detection of streaming data based on logged read/write transactions are provided. In one embodiment, a storage device classifies data as belonging to one of at least three classes based on a set of characteristics and then applies operational parameters to the data depending on the class of the data. Other embodiments are possible, and each of the embodiments can be used alone or together in combination.

### CROSS-REFERENCE TO RELATED APPLICATION

This application claims the benefit of U.S. Provisional Patent Application No. 61/654,020, filed May 31, 2012, which is hereby incorporated by reference herein.

### BACKGROUND

Data stored in a storage device is generally partitioned to two types: sequential data and random data. Typical storage devices determine operational parameters according to the classification of data as either being sequential or random. There are limitations to such devices, and the following embodiments provide improvements over such devices.

### OVERVIEW

Embodiments of the present invention are defined by the claims, and nothing in this section should be taken as a limitation on those claims.

By way of introduction, the below embodiments relate to a method and storage device for detection of streaming data based on logged read/write transactions. In one embodiment, a storage device classifies data as belonging to one of at least three classes based on a set of characteristics and then applies operational parameters to the data depending on the class of the data. Other embodiments are possible, and each of the embodiments can be used alone or together in combination. Accordingly, various embodiments will now be described with reference to the attached drawings.

### BRIEF DESCRIPTION OF THE DRAWINGS

FIG. 1 is a block diagram of an exemplary host device and storage device of an embodiment.

FIG. 2 is a block diagram showing interaction between an application, file system, and storage device of an embodiment.

FIG. 3 is a block diagram showing an arrangement of an application, file system, and storage device of an embodiment.

### DETAILED DESCRIPTION OF THE PRESENTLY PREFERRED EMBODIMENTS

Exemplary Host and Storage Devices

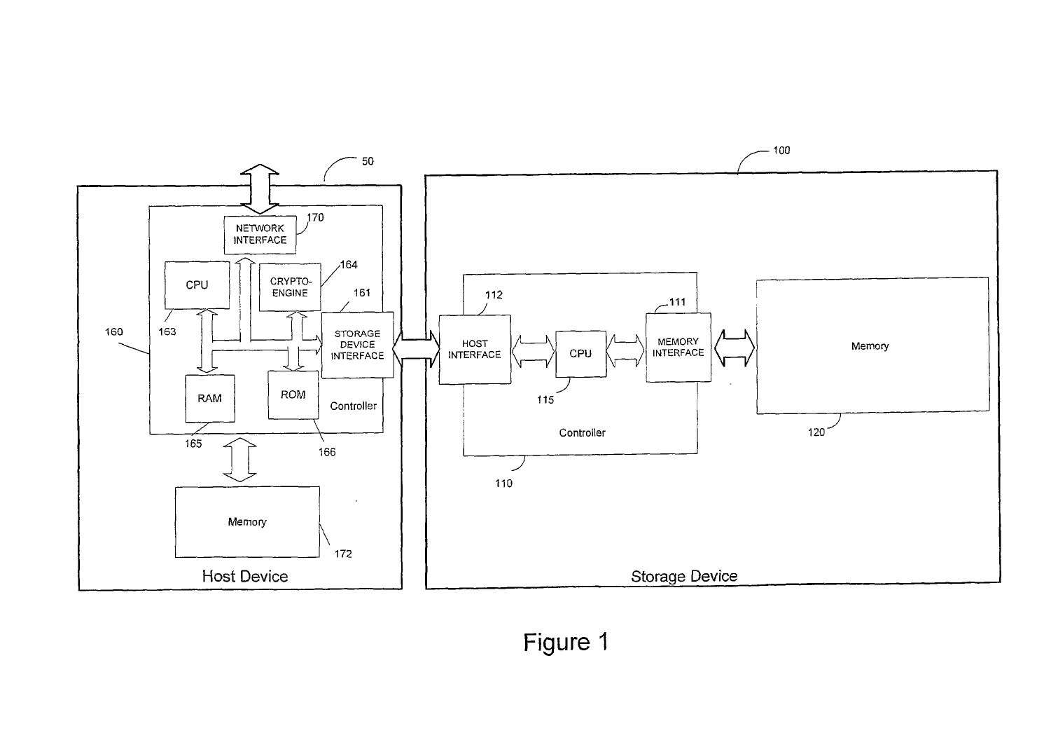

Turning now to the drawings, FIG. 1 is a block diagram of a host device 50 in communication with a storage device 100 of an embodiment. As used herein, the phrase “in communication with” could mean directly in communication with or indirectly in communication with through one or more components, which may or may not be shown or described herein. For example, the host device 50 and storage device 100 can each have mating physical connectors (interfaces) that allow the storage device 100 to be removably connected to the host device 50. The host device 50 can take any suitable form, such as, but not limited to, a mobile phone, a digital media player, a game device, a personal digital assistant (PDA), a personal computer (PC), a kiosk, a set-top box, a TV system, a book reader, or any combination thereof. In this embodiment, the storage device 100 is a mass storage device that can take any suitable form, such as, but not limited to, a handheld, removable memory card (such as a Secure Digital (SD) card or a MultiMedia Card (MMC)), a universal serial bus (USB) device, and a removable or non-removable hard drive (e.g., magnetic disk or solid-state drive). Alternatively, the storage device 100 can take the form of an embedded memory (e.g., a secure module embedded in the host device 50), such as an iNAND™ eSD/eMMC embedded flash drive by SanDisk Corporation. In the below examples, the storage device 100 takes the form of an eMMC device. The storage and host devices 100, 50 can be physically co-located but logically separated.

As shown in FIG. 1, the storage device 100 comprises a controller 110 and a memory 120. The controller 110 comprises a memory interface 111 for interfacing with the memory 120 and a host interface 112 for interfacing with the host 50. The controller 110 also comprises a central processing unit (CPU) 115. The controller 110 can be implemented in any suitable manner. For example, the controller 110 can take the form of a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller, for example. Examples of controllers include, but are not limited to, the following microcontrollers: ARC 625D, Atmel AT91SAM, Microchip PIC18F26K20, and Silicon Labs C8051F320. The memory 120 can take any suitable form. In one embodiment, the memory 120 takes the form of a solid-state (e.g., flash) memory and can be one-time programmable, few-time programmable, or many-time programmable. However, other forms of memory, such as optical memory and magnetic memory, can be used. It should be noted that the storage device 100 shown in FIG. 1 is but one of many possible implementations.

Turning now to the host device 50, the host device 50 comprises a controller 160 that has a storage device interface 161 for interfacing with the storage device 100 and a network interface 170 for interfacing with a network. The network interface 170 can use any suitable technology, such as, but not limited to, a wireless transceiver for wirelessly communicating with the network or a wired connection for a network connector, such as an Ethernet cable. The controller 160 also comprises a central processing unit (CPU) 163, a crypto-engine 164 operative to provide encryption and/or decryption operations, read access memory (RAM) 165, and read only memory (ROM) 166. The storage device 100 also contains a memory 172 for storing, for example, applications (apps) and programs (e.g., a browser, a media player, etc.) used in the operation of the host device 50. The controller's RAM 165 and/or the memory 172 can be used as a buffer for storing commands to be sent to the storage device 100. The host device 50 can contain other components (e.g., a display device, a speaker, a headphone jack, a video output connection, etc.), which are not shown in FIG. 1 to simplify the drawings. Also, other implementations of the host device 50 are possible. For example, an implementation of the present embodiment may not include one or more components shown in FIG. 1, such as the crypto-engine.

In some environments, the host device 50 is operable to render content stored in the storage device 100. As used herein, “content” can take any suitable form, including, but not limited to, a song, a movie, a game, an application (“app”), a game installer, etc. Depending on the type of content, “render” can mean playing (e.g., when the content is a song or movie), deciphering (e.g., when the content is a game installer), or whatever action is needed to “enjoy” the content. In some embodiments, the host device 50 contains the necessary software to render the content (e.g., a media player), whereas, in other embodiments, such software is provided to the host device 50 by the memory device 100 or another entity.

Brief Overview of the Process of Writing to and Reading from a Storage Device

The process of writing to and reading from a storage device can be generally described as a process involving three different entities: an application, a file system, and a storage device. The application is typically configured to create files, write or read from files, change a file, delete a file etc. The application device is further configured to decide whether to write a large bulk of data (e.g. in a USB side load application, file copy, picture taking, movie recording etc) or to write the same location randomly over and over again (data base application, configuration files which are rapidly changing etc).

The file system is typically configured to perform allocation and de-allocation of memory, and all the bookkeeping associated. For that purpose the file system may manage a number of tables, such as tables of allocated and de-allocated memory addresses, tables of creation time of files, change time of files, deletion time of files etc. Other tables (not mentioned here) may also be managed by the file system. Typically, these tables are internal to the file system and are not reported to other devices (such as the application device or the storage device).

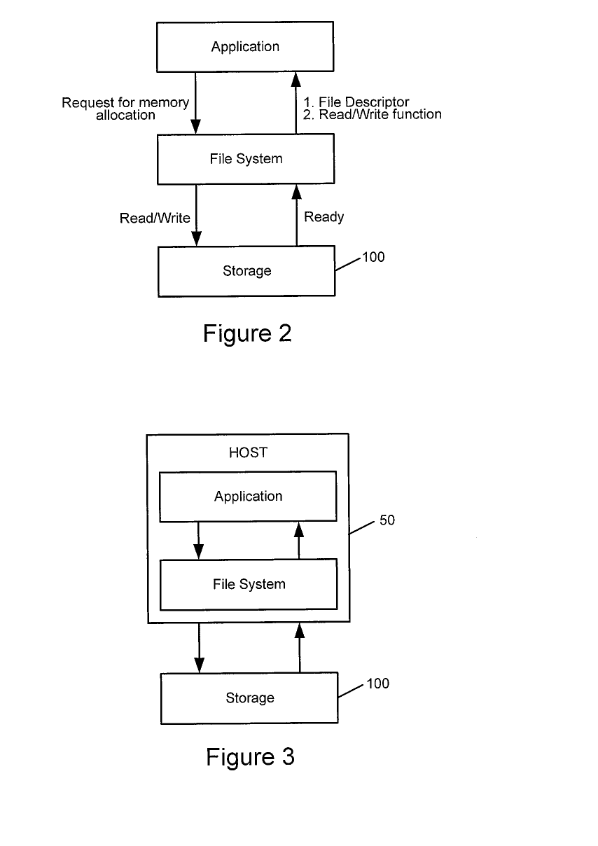

The storage device is typically configured to perform the physical writing of the data into a physical memory array (preferably a non-volatile memory). Typically, the storage device will perform a mapping of the logical addresses which were communicated by the file system into physical addresses of memory. However, in some implementations some of the functionalities of the file system are implemented inside the storage device. The storage device is also configured to determine the operational parameters which will be associated with data which is stored in the memory, or data which is to be stored to the memory. Typical parameters include parameters related to the amount of data that is to be read/written in one command, and parameters related to a data cleanup and management procedures, sometimes referred to as Garbage Collection (GB). Other parameters which may be managed by the storage device are related to error protection, where a partial list of parameters includes parameters related to a type of encoding to be used (e.g. parameters related to the type of code, where two popular types of codes are DPC and BCH), parameters related to a length of codewords, amount of parity bits, parameters related to interleaving of the codewords, and parameters related to decoding (e.g. hard decoding, vs. soft decoding, number of soft bits to be read for decoding, number of iterations etc.). Typically prior art systems determine the storage parameters by classifying the data into one of 2 classes of data: Sequential data, and Random data. A detailed description of Sequential data and Random data is provided herein, after describing the relationship and interface between the application, file system and storage devices. This relationship may be implemented by a system comprised of 3 devices with a bi-directional communication as depicted in FIG. 2.

The application is configured to send communication signals to the file system device requesting an allocation of new memory for writing new data or a request to de-allocate previously allocated memory for deleting existing data stored in the memory. The application device is also configured to receive from the file system a communication signal approving or denying the application's request. In case of approval, the communication signals from the file system will typically comprise of a file descriptor (pointer), and a function through which the application may read/write. The file system is typically configured to receive requests from the application to allocate a certain amount of memory or to de-allocate memory which was previously allocated. The file system determines whether there is available memory to fulfill the application's request. If it determines that there is available memory the file system will update the memory bookkeeping tables (internally in the file system) and send a communication back to the application. The communication will comprise a file descriptor, which is a pointer to which the application can relate while writing the file, and a function through which the application can write. The application may then write the file as if it is writing to a temporary volatile memory such as a RAM (which is usually the case). Typically the file system tries to allocate a contiguous block of memory because the performance will be better when a file is spread along a minimum number of fragments. In case the file system can find a contiguous block of memory which is sufficient it will allocate it for the application, but if the file system cannot find a contiguous block, (e.g. due to fragmentation), then it will allocate few fragments which overall suffice to meet the size requested by the application. The file system is also typically configured to send read/write commands to the storage device. A typical write command will comprise of a small header defining the type of the command, (‘write’), followed by the data to be written to memory. The storage device is configured to perform the actual writing to the physical memory (not depicted) and report to the file system when it is ready to receive a new command. Typically this is the only communication signal sent from the storage device to the file system device. All the other functions mentioned above are done at the storage device in an independent manner, without communicating to the file system. However, implementations where the storage communicates one or more of the parameters to the file system may also be considered. Since the focus of the present disclosure are the parameters managed by the storage device, and associated with the sequential and random data stored (or to be stored) in the memory, the model that will be referred to in the sequel is the model depicted in FIG. 3 comprising of a host device and a storage device, where the host device itself comprises an application and a file system.

Sequential and Random Data

The memory data stored in the memory managed by the storage device are generally partitioned to two types of data: sequential data and random data. Prior art storage devices typically determine the operational parameters, such as the parameters of the storage device mentioned above, according to the classification of the data into either sequential or random. Sequential data is data for which the vast majority of write commands associated with the data are in sequence. A set of writing commands is said to be in sequence if the initial address for each command exactly follows the final address of the preceding write command. So if the final address for a command is address n, the initial address of the following command is n+1. Optionally it may be also required that the length of each command in the sequence will be an integer multiple of the length of a minimal unit for writing into the memory, denoted as a page. Further optional it may sometimes be required that the initial addresses of all the commands in the sequence have a common offset from the first address in a page, i.e. if the initial address of the first command is at an offset of 3 from the beginning of a page, then the initial address of any other command in the sequence is at an offset of 3 from the beginning of a (different) page (and consequently, the final address of any command in the sequence is at an offset of two from the beginning of a page).

A sequential data is denoted as pure-sequential if all the write commands associated with the data are in sequence. In other words there are no write commands associated with the data other than sequential write commands. In yet other words, pure-sequential data is data that is written to enumerated units of memory where the enumeration is contiguous, and there are no gaps, and no other memory sectors associated with the data. For example if a data sequence occupies units 10000-80000 with no gaps at all then the data is considered as pure-sequential. In practice instances of pure-sequential data seldom happen. There is almost always a small amount of sectors which are written out of sequence even in the most likely sequential cases. A case of pure-sequential data may happen in a scenario known as ‘host test’. In this case a host bypasses the mechanisms of the file system and writes directly to the storage device. A ‘host test’ may be implemented by host for the purpose of internal testing of the storage device, but it does not represent ‘real life’ scenario. In most ‘real life’ cases the pure-sequential data will always be augmented by random data, typically originating from host, and in particular from the file system device. But there are implementations which are very close to sequential, such as USB side load. This example relates to a real life implementation when a USB device is loaded from a PC with a large amount of data, (such as copying the full content of music folders, picture folder and/or video folders). Data that is not sequential is considered by prior art system as random data. Random data typically originates from applications such as updating a data base application, writing and updating configuration files which are rapidly changing etc. Random data is typically written to random memory units where the units may be far apart from each other, and each unit contains only a small piece of data, for example data that is assigned to units no. 12-99, 1111-1220, and 3000-3100 will be considered random data.

The enumerated memory units may be physical memory units enumerated by their physical address, and the enumeration is managed by the storage device itself. Alternatively, the enumerated memory units may be Logical Blocks Addresses (LBA), and the enumeration may be managed by a higher level entity such as a host (or the application).

The operational parameters for managing of sequential data and random data in the storage device are different. For example writing to a sequential number of addresses of memory (e.g. the example given above of 10000-80000), may be done in one command, but writing to 70000 random addresses (or 700 groups, each containing 100 contiguous addresses) requires multiple write commands. Other parameters may also differ between sequential data and random data. For example, for sequential data, the parameters associated with managing the memory may be different from the parameters associated with random data. As a particular example, Garbage Collection (GC) for sequential data may be low and in some cases no GC is required at all. For random data GC must take place to reclaim obsolete flash area caused by redundant writes and holes in the sequential LBA range. Other parameters which may be managed by the storage device are related to error protection, where a partial list of parameters includes parameters related to a type of encoding to be used (e.g. parameters related to the type of code, where two popular types of codes are LDPC and BCH), parameters related to a length of codewords, amount of parity bits, parameters related to interleaving of the codewords, and parameters related to decoding (e.g. hard decoding, vs. soft decoding, number of soft bits to be read for decoding, number of iterations etc.).

If the memory management (typically in the storage device, but in some cases may be implemented in higher layers) detects sequential data then it may treat it in a different way than random data. An incorrect detection may significantly degrade the performance of the system. For example, if sequential data is incorrectly detected as random data, then the read and write speeds which the management will use for this data will be much lower than the actual capability of the system. In implementations, such as a video camera, this may be critical. A video camera operates in a semi-realtime mode, and there is a certain rate of data that it transfers to the storage. If the storage management incorrectly detects the data from a video camera application as random, it will operate in lower rate than the rate of the camera and this mismatch may cause loss of data frames, or corruption of data frames or both.

On the other hand if random data is incorrectly detected as sequential data, this may result in performance degradation. The amount of resources to handle sequential data is limited, thus wasting the resources when they are not required will eventually degrade the random performance as well as performance of real sequential data. In addition storage of random data should be optimized for random access to gain best performance for it. For example the GC process should be applied in a different manner for random data and for sequential data, and the error correction codes for random data and sequential data may also differ.

In theory everything is simple. Two types of data, random and sequential require different handling, e.g. via associating different operating parameters with random data and sequential data. In practice sequential data is not always pure-sequential and may contain a small amount of random data. For example whenever there is a file system between the data origin and the memory, the file system will add additional random data into the sequential data. Consider for example a video camera whose output data transferred to the memory is sequential in nature, but it also contains meta-data generated by the file system and not directly related to the picture frames. This meta-data is random in nature. Moreover, there may be small gaps in the enumerated memory units storing the picture frames of the video due to small failures during transmission or any other reason.

The read and write performance of data which contain a mixture of sequential data with a small amount of random data (e.g. video camera) cannot match the performance of pure-sequential data (e.g.: ‘host test’). However it may be higher than the read and write performance of random data. The decision whether to relate to specific data as sequential or random data may typically be done by the storage device (e.g. via memory controller), by analysis. The decision may be applied to the same data, i.e. the same data that is analyzed as sequential will be read or written with parameters of sequential read/write. Alternatively the analysis may be related to a first data currently stored in the memory, but the decision will affect a second data (e.g. the analysis may be done on the latest data which was stored in the memory, but the parameters will be applied to (near) future data that is to be stored in the memory).

One example for performing an analysis may be by tracking the history of the read and write commands to a flash memory (without accessing the flash memory array). The analysis tool performs bookkeeping of the memory addresses which are assigned for the data, and can build a map of the memory usage and occupancy according to the bookkeeping information. While analyzing write/read transactions to predict the flash system behavior and performance the write/read Transactions are currently defined as random or sequential patterns. However, the binary situation of having only two types of data, sequential and random is not optimal. The optimal operational parameters of pure-sequential data may be different from the optimal operational parameters of sequential data that originated in a USB side load application, and different from data resulting from a video camera application, which operates in a semi-real-time-environment. Random data may be even more diverse. Some applications may write to multiple locations, where each location will occupy only a small number of memory addresses, while other applications may occupy fewer locations where each location occupies a larger number of addresses. The optimal operational parameters of these two examples may differ materially. Therefore there is a need to define additional data types, and the parameters which are associated with the additional data types.

Embodiments Relating to Detection of Streaming Data Based on Logged Read/Write Transactions

The present embodiment teaches novel methods for operating a memory system by determining operational parameters for reading and writing data into a memory. According to another preferred embodiment of the present invention a new metric will be defined to determine a ‘distance’ of data stored in a memory array from a pure-sequential data, and the operational parameters for reading and writing will be determined as a function of the distance from pure-sequential data. In particular a new data type will be defined and denoted as stream data. Stream data is data that is in close proximity of pure-sequential data according to a defined metric. In particular, four parameters are considered in this particular embodiment when computing the metric (although a subset or other parameters can be used):

1. Consecutive In-Sequence I/O Commands

A minimal number of in-sequence I/O commands will be required to define data as stream data. This parameter counts only the in sequence commands, and does not count out of sequence commands. The counter can be reset to zero if conditions 3 and 4 fail.

2. Data Length

A minimal data length in the in-sequence commands of the previous step will be required to define data as stream data. This parameter is also a parameter related to the in-sequence commands. The length can be reset to zero if conditions 3 and 4 fail.

3. Number of Addresses out of Sequence

A maximal number of ‘out of sequence’ addresses will be allowed to define data as stream data. This parameter is obviously a parameter related to the out-of-sequence commands (i.e. the random data that was added to the sequential data). The total data length written out of sequence can be another condition where a data including more than a predefined number of data written out of sequence may not be defined as stream.

4. Gap Length

A maximal gap length (single gap and/or accumulated) will be allowed to define data as stream data. This parameter is also a parameter related to the in-sequence commands.

In one embodiment, some or all of the four parameters are configurable by the user. Also, the parameters may in general be partitioned into parameters related to the in-sequence commands and parameters related to the out-of-sequence commands. According to one embodiment of the invention operating the memory system will comprise of assigning a type to data stored in the memory, wherein the type is chosen from a set comprising of sequential, stream, and random, wherein the type is determined as a function of the 4 parameters described above. Preferably the different types of data will be managed in a different way. For example, the data structures associated with storing the types of data will be a function of the type of the data. The data structure associated with sequential data may be different than random data or steam data. In more detail, for random data, a data structure allowing storage of small fragments of data will be allowed, so the total number of data fragments will be large. This will require a large management table including indices to each of the fragments. Sequential data will be stored in larger continuous units, so the indexing of the same amount of sequential data will be simpler and smaller. Stream data may be stored in a hybrid fashion where the sequential part of the data is stored as sequential, and the other parts of the data are stored as random data. Other data structures may also be possible. As another example, the storage device may allocate different parts of the memory for the different data types. The different parts may either be different physical parts, of different logical parts. As yet another example, a memory mode may be set as a function of the data type. The memory mode may include the number of bits stored in each of the memory cells of a flash memory, where one data type maybe stored in a mode of storing only 1 bit per cell (known as SLC mode), while another data type will be stored according to a mode allowing storing of 2 bits per cell, and yet another data type will be stored according to a mode allowing 3 bits per cell. (Storing more than 1 bit per cell is commonly referred to as MLC mode). In another example, the operational parameter can associate a guaranteed performance measures to each of the data types. In particular, the guaranteed performance can be achieved by associating corresponding garbage collection parameters.

As another example, a pure sequential type can be identified if parameters 3 and 4 are zero.

Other examples may include different operational parameters such as a different error code, and/or different parameters of the error correction codes for the 3 types. Other examples may include different interleaving parameters. Other parameters may include different garbage collection (GB) parameters, where for example sequential data will be associated with a small amount (or even no) GB, while stream data will be associated with medium GB, while random data will require more intensive GB. Not all parameters need be different for different types of data, but in a preferred embodiment for any 2 types of data there will be at least one operational parameter which differs between the 2 types. Other implementations may include data which are determined to belong to different data types, (e.g. sequential, and stream), but their operational parameters are identical. That is, for each two different classes, at least one of the operational parameters can be different, or the operational parameters can be different for some but not all of the classes of data.

For example a data for which the data length of the previous in-sequence commands is 1 MB, the number of out of sequence commands is 8, and the gap length is 32 KB may be defined as stream data

An example of different operational parameters for garbage collection parameters that can ensure a guaranteed performance is the following: if for each 4 MB of data received from the host device, a total time of one second is allowed for performing storing of the data and garbage collection operations, then a minimum performance of 4 MB/s is guaranteed.

According to another embodiment of the invention a storage device will configure the operational parameters for handling data stored in the memory (or data associated with the data under analysis such as data that is to be stored into the memory immediately following the data under analysis) according a metric that defines the distance between the data and pure-sequential data. This differs from the first embodiment by allowing a large number of configurations of the operation parameters, and is not limited to a set of three types of data.

### CONCLUSION

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

What is claimed is:

1. A storage device comprising:
a host device interface through which the storage device can communicate with a host device;
a memory; and
a controller in communication with host device interface and the memory, wherein the controller is configured to:
classify data to be stored in the memory as belonging to one of at least three classes based on a set of characteristics;
apply operational parameters to the data depending on the class of the data.

2. The storage device of claim 1, wherein the set of characteristics comprises one or more of the following: consecutive in-sequence I/O commands, data length, number of addresses out of sequence, and gap length.

3. The storage device of claim 1, wherein at least one of the characteristics is configurable by a user.

4. The storage device of claim 1, wherein the at least three classes comprise the following: sequential data, stream data, and random data.

5. The storage device of claim 1, wherein one of the operational parameters associates data structure parameters to the each of the classes.

6. The storage device of claim 1, wherein one of the operational parameters associates a physical location in the memory to each of the classes.

7. The storage device of claim 1, wherein one of the operational parameters associates a memory mode to each of the classes.

8. The storage device of claim 1, wherein one of the operational parameters associates a guaranteed performance measures to each of the classes.

9. The storage device of claim 8, wherein the guaranteed performance is achieved by associating corresponding garbage collection parameters to each of the classes.

10. The storage device of claim 1, wherein one of the operational parameter is an error code.

11. The storage device of claim 1, wherein one of the operational parameter is a garbage collection parameter.

12. The storage device of claim 1, wherein for two different classes, at least one of the operational parameters is different.

13. The storage device of claim 1, wherein the operational parameters are different for some but not all of the classes of data.

14. A method for classifying data the method comprising:
performing the following in a storage device having a memory and in communication with a host device:
classifying data to be stored in the memory as belonging to one of at least three classes based on a set of characteristics; and
applying operational parameters to the data depending on the class of the data.

15. The method of claim 14, wherein the set of characteristics comprises one or more of the following: consecutive in-sequence I/O commands, data length, number of addresses out of sequence, and gap length.

16. The method of claim 14, wherein at least one of the characteristics is configurable by a user.

17. The method of claim 14, wherein the at least three classes comprise the following: sequential data, stream data, and random data.

18. The method of claim 14, wherein one of the operational parameter associates data structure parameters to the each of the classes.

19. The method of claim 14, wherein one of the operational parameter associates a physical location in the memory to each of the classes.

20. The method of claim 14, wherein one of the operational parameter associates a memory mode to each of the classes.

21. The method of claim 14, wherein one of the operational parameter associates a guaranteed performance measures to each of the classes.

22. The method of claim 21, wherein one of the guaranteed performance is achieved by associating corresponding garbage collection parameters.

23. The method of claim 14, wherein one of the operational parameter is an error code.

24. The method of claim 14, wherein one of the operational parameter is a garbage collection parameter.

25. The method of claim 14, wherein the operational parameters are different for each class of data.

26. The method of claim 14, wherein the operational parameters are different for some but not all of the classes of data.

27. The method of claim 14, wherein the storage and host devices are physically co-located but are logically separated.
